(19) United States
(12) Patent Application Publication
(10) Pub. No.: US 2009/0039190 A1
(43) Pub. Date: Feb. 12, 2009

(54) ELECTRIC FISHING REEL

(75) Inventor: Tomoyuki AMANO, Tokorozawa-shi (JP)

Correspondence Address: SUGHRUE-265550, 2100 PENNSYLVANIA AVE. NW, WASHINGTON, DC, 20037-3213, US

(73) Assignee: DAIWA SEIKO, INC, Higashikurume-shi (JP)

(21) Appl. No.: 12/187,789

(22) Filed: Aug. 7, 2008

(30) Foreign Application Priority Data
Aug. 8, 2007 (JP) 2007-207016
Aug. 10, 2007 (JP) 2007-209391

(51) Int. Cl. A01K 89/017

(52) U.S. Cl. 242/250

(57) ABSTRACT

An electric fishing reel includes a motor for driving a spool, which is accommodated within a motor casing, and a mechanical change-speed mechanism which is coupled to the motor and a power transmission mechanism for transmitting rotation of the motor to the spool and is adapted to switch transmission of power of the motor to the spool between a high-speed power transmission state and a low-speed power transmission state. A first wall portion and a second wall portion apart from the first wall portion in the axial direction are provided within the motor casing. An epicycle reduction gear mechanism for reducing the rotating speed of the motor is installed between the first wall portion and the second wall portion and a planetary gear carrier is supported on the second wall portion. An output gear which meshes with the mechanical change-speed mechanism is attached integrally to the planetary gear carrier.

### BACKGROUND OF THE INVENTION

The present invention relates to an electric fishing reel which includes a spool driving motor which drives a spool which is attached rotatably to a reel main body for winding, and more particularly to an electric fishing reel which includes a mechanical change-speed mechanism for changing the winding speed of the spool by switching rotating directions of the spool driving motor between forward and backward directions.

When fishing or angling for fishes in the deep water such as a boat fishing, electric fishing reels (hereinafter, referred to as “electric reels”) are widely used. With a view to enabling a variety of power supply winding operations in association with a change in the conditions of a fishing area, JP-A-2001-148978 discloses an electric reel which includes a mechanical change-speed mechanism G in which a high-speed gear transmission mechanism E and a low-speed gear transmission mechanism F, which have different gear ratios, are coupled to a motor output portion B of a spool driving motor A (hereinafter, referred to as a “motor”) which can rotate both forwards and backwards and a power transmission mechanism D for transmitting the driving force of the motor to a spool C therebetween in such a manner that power can be transmitted therebetween, whereby by operating a change-speed switch, either of the high-speed gear transmission mechanism E and the low-speed gear transmission mechanism F is selectively made to enable power transmission by switching rotating directions of the motor to both the forward and backward directions, so as to switch the winding speed of the spool between a high speed state and a low speed state.

In addition, with a view to silencing noise produced at the time of high-speed driving by improving the aforesaid electric reel, JP-A-2006-325481 discloses an electric reel in which an epicycle reduction gear mechanism is installed between the motor output portion of the motor and an input portion of the mechanical change-speed mechanism.

Thus, according to this electric reel, since the rotation (rotating speed) of the motor is decelerated once by the epicycle reduction gear mechanism to be inputted into the mechanical change-speed mechanism, the meshing noise at the time of high-speed driving can be reduced compared with the electric reel disclosed in JP-A-2001-148978, thereby making it possible to realize the silencing of noise.

In the electric reel disclosed in JP-A-2006-325481, however, since the epicycle reduction gear mechanism and the mechanical change-speed mechanism are accommodated and disposed within a single space provided within the real main body on the opposite side to the side where the handle is provided, the meshing noises of the respective gears resonate, and there still remains a problem to be solved with respect to silencing noise on the surface of the housing of the real main body.

In addition, as has been described before, in the electric reel, the rotation of the motor is decelerated once by the epicycle reduction gear mechanism to thereafter be inputted into the mechanical change-speed mechanism. However, due to the construction in which the driving force of the spool is finally transmitted to the power transmission mechanism from the output shaft via the meshing transmission mechanism made up of the high-speed gear transmission mechanism and the low-speed gear transmission mechanism in either of the high-speed winding driving state and the low-speed winding driving state, even though the suppression of resonance of meshing noise is attempted to be realize by reducing the rotating speed of the motor by the epicycle reduction gear mechanism, due to many gears being involved in the transmission of the driving force of the spool, the power transmitting portion cannot be silenced effectively in reality, and the construction of the electric reel has had to be complicated.

Further, the power transmission mechanism D includes a spool shaft driving gear L attached to a spool shaft K and a coupling gear N meshing with an output gear M of the mechanical change-speed mechanism G. With the reeling operation by a handle O, the spool C is driven to be rotated. In order to enable the motor A to rotate in both the forward and backward directions, an one-way clutch P is attached to the coupling gear N. At the time of the reeling operation by the handle O, the rotation of the coupling gear N is restricted due to the wedge of the one-way clutch P and with this reaction, the driving force of the handle O is transmitted to the spool C through a epicycle reduction gear mechanism Q.

As shown in the drawing, the coupling gear N is arranged so that the coupling gear N is rotatably supported by a supporting shaft S fixed to a supporting plate (set plate) R through a bearing T and the rotation in one direction is restricted by the one-way clutch P arranged apart from the bearing T in the axial direction.

The electric fishing reel J restricts the coupling gear N from rotating in one direction by attaching the one-way clutch to the coupling gear N of the power transmission mechanism G in order to enable the driving of the spool C by the reeling operation of the handle O and enable the motor to rotate in both the forward and backward directions. However, due to the structure in which the bearing T and the one-way clutch P are arranged apart from each other in the axial direction of the pivot S, the support portion of the coupling gear N becomes large in the axial direction and the whole size of the electric fishing reel becomes large.

Further, to realize the function of restricting the rotation by the wedge, the pivot S made of the hard material in which the steel is quenched for supporting the one-way clutch P is fixed to the support plate R so that a base portion U is directed toward the spool C. Therefore, the base portion U is arranged close to a magnet W attached to a spool flange V for detecting the rotation of the spool.

Therefore, the magnetic effect of the magnet W rotated together with the spool C deteriorates the free rotation performance of the spool C.

### SUMMARY OF THE INVENTION

The invention has been made in view of the situations, and an object thereof is to provide an electric reel which attempts to realize a reduction in resonance of the meshing noise of the gears by improving the conventional electric reel.

Another object of the invention is to provide an electric reel which attempts to realize a compact size reel as whole without affecting the free rotation performance of the spool.

To achieve the object, the present invention provides the following arrangements.
(1) An electric fishing reel comprising:

a reel main body;

a spool rotatably supported by the reel main body for winding a fishing line;

a motor adapted to rotate forwards and backwards for driving the spool;

a motor casing which is provided on the reel main body, accommodates the motor therein and includes a first wall portion and a second wall portion spaced apart from the first wall portion in an axial direction of an output portion of the motor;

an epicycle reduction gear mechanism which reduces the rotating speed of the motor, is installed between the first and second wall portions and includes a planetary gear carrier which supports planetary gears of the epicycle reduction gear mechanism, is supported on the second wall portion and is integrally attached with an output gear;

a mechanical change-speed mechanism which includes an input gear meshing with the output gear of the planetary gear carrier and switches transmission of power of the motor between a high-speed power transmission state and a low-speed power transmission state by switching rotating directions of the motor; and

a power transmission mechanism which transmits output of the mechanical change-speed mechanism to the spool to rotate the spool.
(2) The electric fishing reel according to (1), wherein

the mechanical change-speed mechanism includes:

a high-speed output shaft to which an output shaft is attached;

a first one-way clutch attached to the high-speed output shaft;

a first input gear attached to an outer ring of the first one-way clutch;

a low-speed output shaft to which an output shaft is attached;

a second one-way clutch which is attached to the low-speed output shaft; and

a second input gear which is attached to an outer ring of the second one-way clutch,

wherein the output gear of the planetary gear carrier meshes with the first and second input gears.
(3) The electric fishing reel according to (2), wherein a high-speed output gear and a low-speed output gear which are attached, respectively, to the high-speed output shaft and the low-speed output shaft mesh with each other, and either of the first and second output gears meshes with a coupling gear of the power transmission mechanism.
(4) The electric fishing reel according to (3), wherein the high-speed output gear, the low-speed output gear and the coupling gear are disposed in a series fashion.
(5) An electric fishing reel comprising:

a reel main body that includes a supporting plate;

a spool shaft rotatably supported by the reel main body;

a spool rotatably supported by the reel main body and rotated by the spool shaft for winding a fishing line;

a motor adapted to rotate forwards and backwards for driving the spool;

an output gear for transmitting rotation of the motor;

a power transmission mechanism which receives rotation from the output gear and transmits the received rotation to the spool shaft; and

a manual handle for driving the spool,

wherein the power transmission mechanism includes:
a coupling gear meshing with the output gear;
a one-way clutch mounted on the coupling gear so that the spool is rotated by the driving force of the manual handle and the driving force of the manual handle is not transmitted to the motor; and
a pivot which supports the coupling gear through the one-way clutch and includes a base fixed to the supporting plate so that the one-way clutch is interposed between the base and the spool in an axial direction of the one-way clutch,

wherein the coupling gear and the output gear are disposed in a series fashion.
(6) The electric fishing reel as set forth in claim 5, wherein

the power transmission mechanism includes a spool shaft driving gear which meshes with the coupling gear and is fixed to the spool shaft, and

the output gear, the coupling gear and the spool shaft driving gear are disposed in a series fashion.

### BRIEF DESCRIPTION OF THE DRAWINGS

FIG. 1 is a cutaway plan view of a main part of an electric reel according to an embodiment of first to third aspects of the invention.

FIG. 2 is an enlarged sectional view showing an epicycle reduction gear mechanism, a mechanical change-speed mechanism and a power transmission mechanism.

FIG. 3 is an enlarged sectional view of the epicycle reduction gear mechanism and the mechanical change-speed mechanism.

FIG. 4 is an exemplary diagram of a power transmission path of the mechanical change-speed mechanism and the power transmission mechanism.

FIG. 5 is a cutaway plan view of a main part of a conventional electric reel.

### DETAILED DESCRIPTION OF THE PREFERRED EMBODIMENTS

Hereinafter, an embodiment of the invention will be described in detail based on the drawings.

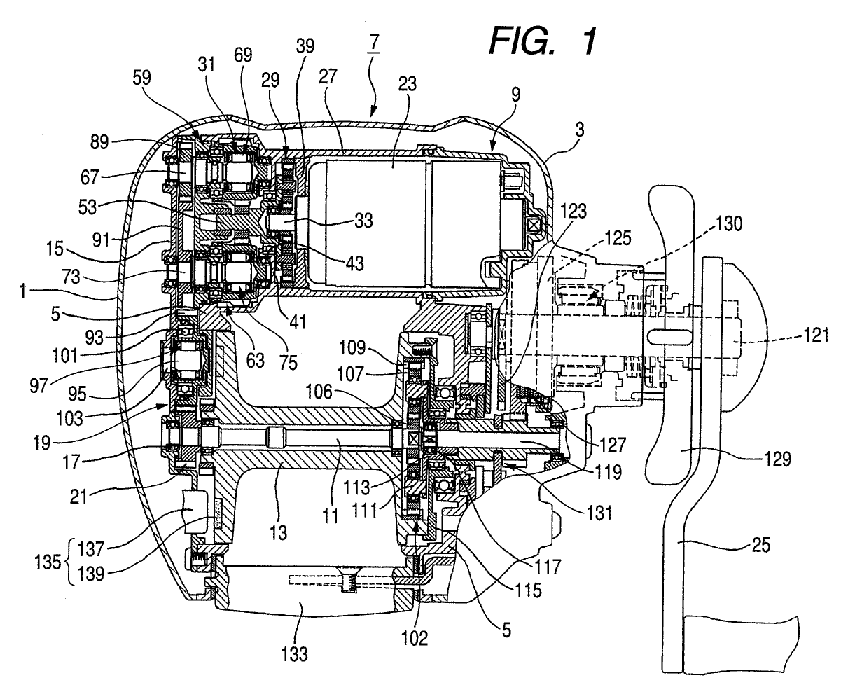

FIGS. 1 to 4 show an embodiment of an electric reel based on the first to third aspect of the invention, and in FIG. 1, reference numerals 1, 3 denote side plates which are attached to a frame 5, and a reel main body 9 of an electric reel 7 according to the embodiment of the invention is made up of both the side plates 1, 3 and the frame 5, a spool 13 being supported rotatably between both the side plates 1, 3 via a spool shaft 11.

The spool shaft 11 penetrates through an axial center of the spool 13, and one end of the spool shaft 11 which lies to face the side plate 1 is supported rotatably on a set plate (a support plate) 15 which is attached integrally to the frame 5 via a bearing 17. In addition, a spool shaft driving gear 21 of a power transmission mechanism 19 is fitted on the side plate 1 end of the spool shaft 11 in such a manner as not to rotate thereon.

The spool 13 rotates in a winding direction when a motor 23 is driven and a handle 25 performs a winding operation, and the motor 23 is stored in a cylindrical motor casing 27 which is formed integrally with the frame 5 in front of the spool 13.

In addition, a first epicycle reduction gear mechanism 29 and a mechanical change-speed mechanism 31, and the power transmission mechanism 19 including the spool shaft driving gear 21 are mounted sequentially between a motor shaft (an output portion of the motor) 33 of the motor 23 and the spool shaft 11 within a portion of the motor casing 27 which lies to face the side plate 1 and the reel main body 9, whereby the rotation of the motor 23 is decelerated/changed in speed by the epicycle reduction gear mechanism 29 and the mechanical change-speed mechanism 31 and is then made to be transmitted from the power transmission mechanism 19 to the spool shaft 11.

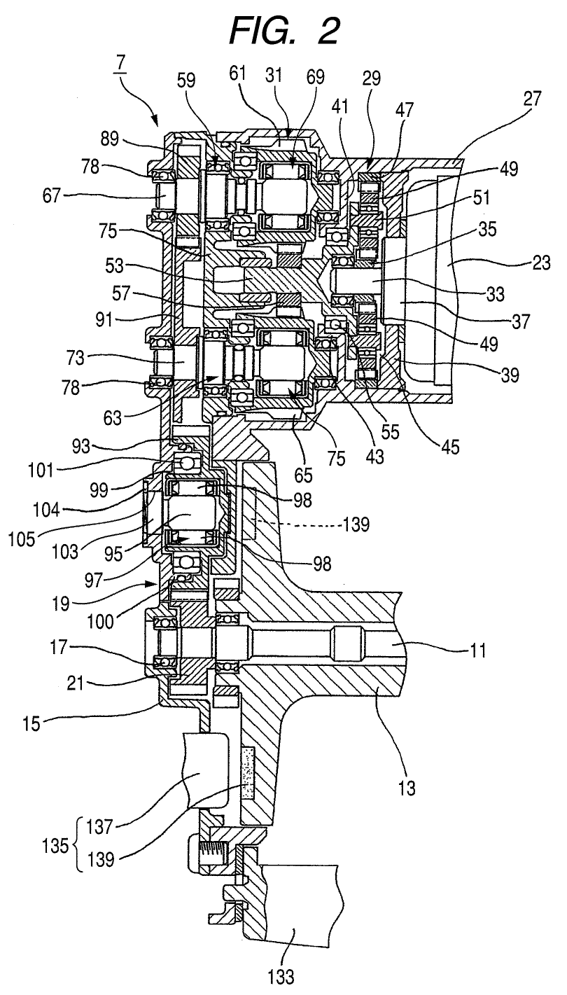

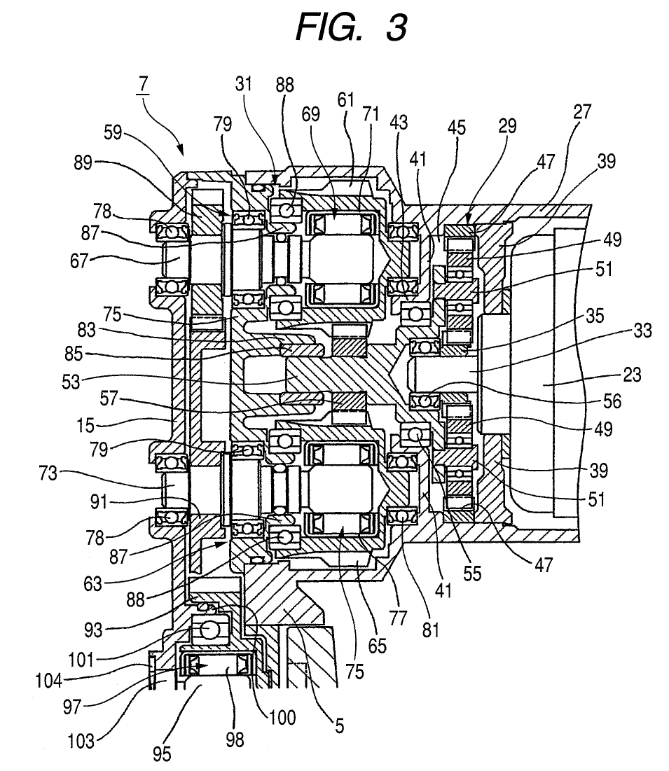

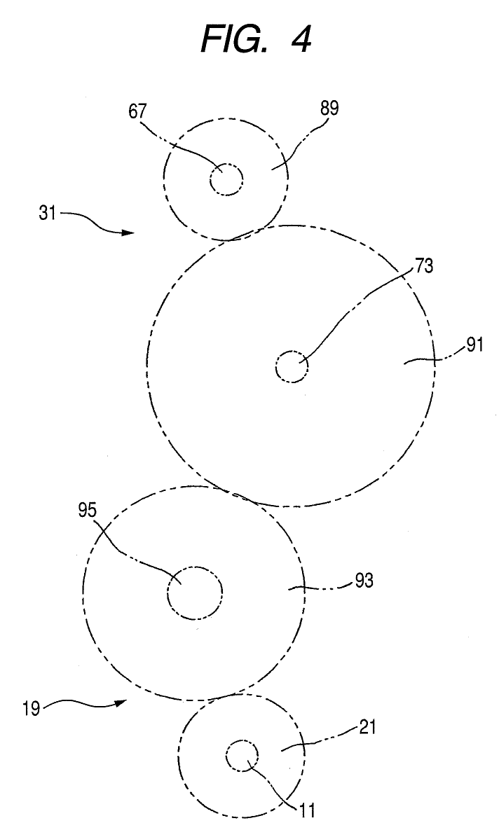

FIG. 2 is an enlarged sectional view showing the epicycle reduction gear mechanism 29, the mechanical change-speed mechanism 31 and the power transmission mechanism 19, FIG. 3 is an enlarged sectional view of the epicycle reduction gear mechanism 29 and the mechanical change speed mechanism 31, and furthermore, FIG. 4 is an exemplary view of a power transmission path of the mechanical change-speed mechanism 31 and the power transmission mechanism 19. In FIG. 2, reference numeral 35 denotes a sun gear of the epicycle reduction gear mechanism 29 which is fitted on the motor shaft 33 in such a manner as not to rotate thereon, and in association with the motor 23 being made to rotate in both forward and backward directions, the sun gear 35 is also made to rotate in both the forward and backward directions.

An annular supporting member is press fitted in an inner circumference of a side of the motor casing 27 which lies opposite to a side thereof which faces the handle 25 so as to form a first wall portion 39 which supports a bearing 37 of the motor 23, and a second wall portion 41 is formed integrally within the motor casing 27 in such a manner as to be spaced apart from the first wall portion 39, a cylindrical supporting portion 43 being provided round the motor shaft 33 as a center shaft.

As is shown in FIGS. 2 and 3, the epicycle reduction gear mechanism 29 is installed between the first wall portion 39 and the second wall portion 41, and the epicycle reduction gear mechanism 29 is made up of internal teeth 47 which is formed on an inner circumference of a storage portion 45 which is defined by the first wall portion 39 and the second wall portion 41 (the internal teeth 47 being preferably made of a metallic material as a separate element and then being integrated into the inside of the motor casing 27) and a plurality of planetary gears 49 which are made to mesh with the internal teeth 47 and the sun gear 35. The planetary gears 49 are supported rotatably on a planetary gear carrier 53 which is formed substantially into a Y-shape in cross section via pivots 51, and the planetary gear carrier 53 is supported rotatably on the supporting portion 43 of the second wall portion 41 and the motor shaft 33 via bearings 55, 56.

Then, when the motor 23 rotates forwards (rotates clockwise, and hereinafter, this being the same) and the sun gear 35 rotates in the same direction, the planetary gears 49 are made to walk round the circumference of the sun gear 35 while revolving counterclockwise on their pivots 51, so as to rotate the planetary gear carrier 53 in a clockwise direction.

On the other hand, when the motor 23 rotates backwards (rotates counterclockwise, and hereinafter, this being the same) and the sun gear 35 rotates in the same direction, the planetary gears 49 are made to walk round the circumference of the sun gear 35 while revolving clockwise on their pivots 51, so as to rotate the planetary gear carrier 53 in a counterclockwise direction.

An output gear 57 is attached integrally to an end of a protruding side of the planetary gear carrier 53 which is supported on the supporting portion 43, and a low-speed input gear (an input portion of the mechanical change-speed mechanism 31) 61 of a low-speed gear transmission mechanism 59 and a high-speed input gear (an input portion of the mechanical change-speed mechanism 31) 65 of a high-speed gear transmission mechanism 63 mesh with the output gear 57. The mechanical change-speed mechanism 31 is made up of the low-speed gear transmission mechanism 59 and the high-speed gear transmission mechanism 65.

As is shown in FIGS. 2 and 3, the low-speed input gear 61 and the high-speed input gear 65 have the same outside diameter and their gear ratios are set to be the same in relation to the output gear wheel 57. The low-speed input gear 61 is fitted on an outer ring 71 of a one-way clutch 69 mounted on a first pivot (a low-speed output shaft) 67 in such a manner as not to rotate on the outer ring 71, and the high-speed input gear 65 is fitted on an outer ring 77 of a one-way clutch 75 which is mounted on a second pivot (a high-speed output shaft) 73 in such a manner as not to rotate on the outer ring 77.

In transmitting force, the one-way clutches 69, 75 are set to rotate in opposite directions, and the one-way clutch 69 which is mounted on the pivot 67 on the side of the low-speed input gear 61 is made to transmit the rotational force of the low-speed input gear 61 to the pivot 67 through its wedging action when the low-speed input gear 61 rotates forwards as a result of the motor 23 rotating backwards, whereas when the low-speed input gear 61 rotates backwards as a result of the motor 23 rotating forwards, the one-way clutch 69 is made not to transmit its rotational force to the pivot 67 (the pivot 67 only spinning).

On the other hand, the one-way clutch 75 which is mounted on the pivot 73 on the side of the high-speed input gear 65 is made not to transmit its rotational force to the pivot 73 (the pivot 73 only spinning) when the high-speed input gear 65 rotates forwards as a result of the motor 23 rotating backwards, whereas the one-way clutch 75 is made to transmit the rotational force of the high-speed input gear 65 to the pivot 23 through its wedging action when the high-speed input gear 65 rotates backwards as a result of the motor 23 rotating forwards.

In addition, as is shown in FIG. 3, the pivots 67, 73 are supported rotatably by a lid element 75 which closes an opening in the side of the motor casing 27 which lies opposite to the side thereof which faces the handle 25, the set plate 15 which covers the lid element 75 and is attached to the frame 5, and bearings 78, 79, 81 which are installed respectively between an outer circumference of the supporting portion 43 and an inner circumference of the motor casing 27. Then, a protruding end of the planetary gear carrier 53 is supported by a metallic bearing 85 within a cylindrical supporting portion 83 which is provided in the center of the lid element 75 in such a manner as to protrude therefrom, and the low-speed input gear 61 and the high-speed input gear 65 are supported respectively on outer circumferences of two cylindrical supporting portions 87 which are provided on the lid element 75 by bearings 88.

In addition, as is shown in FIG. 3, a low-speed output gear 89 with a small diameter of the low-speed gear transmission mechanism 59 is fitted on the pivot 67 which protrudes from the lid element 75 in such a manner as not to rotate on the pivot 67, and a high-speed output gear 91 with a large diameter of the high-speed gear transmission mechanism 69 is fitted on the pivot 73 which protrudes from the lid element 75 in such a manner as not to rotate on the pivot 73, the low-speed output gear 89 and the high-speed output gear 91 being made to mesh with each other as is shown in FIGS. 3 and 4. A coupling gear 93 of the power transmission mechanism 19 is made to mesh with the high-speed output gear 91 as is shown in FIGS. 2 and 4.

As is shown in FIGS. 1 and 2, the power transmission mechanism 19 is made up of the spool shaft driving gear 21 and the coupling gear 93 which is interposed between the spool shaft driving gear 21 and the high-speed output gear 91 in such a manner as to mesh therewith, and the spool driving shaft 21 and the coupling gear 93 are disposed in series with the low-speed output gear and the high-speed output gear 9. In addition, the supporting plate 15 which supports the pivots 67, 73 and the spool shaft 11 via the bearings 78, 17 is formed into a flat shape which extends along the low-speed output gear 89, the high-speed output gear 91, the coupling gear 93 and the spool driving gear 21 which are disposed and coupled together in series.

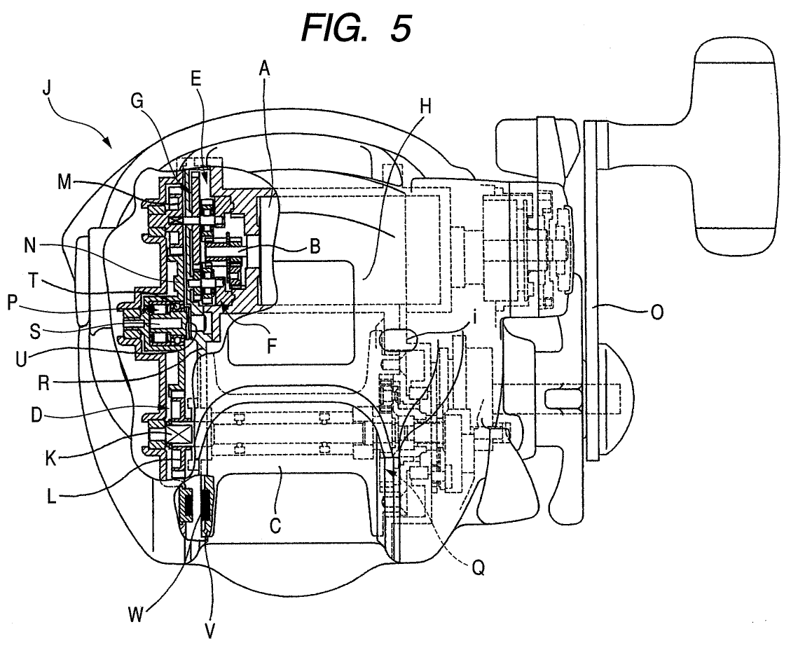

Thus, as is shown in FIG. 2, the coupling gear 93 is fitted on an outer ring 99 of a one-way clutch 97 which is attached to the supporting plate 115 via a pivot 95 in such a manner as not to rotate on the outer ring 99 and is supported rotatably on a supporting portion 100 of the supporting plate 15 by a bearing 101. As with the electric reel J in FIG. 5, when the handle 25 is operated for winding, the rotation of the coupling gear 93 is prevented by a wedging action of the one-way clutch 97, that is, the driving force of the handle 25 is made not to be transmitted to the motor 23, and by virtue of a reaction force produced due to the driving force of the handle 25 being prohibited from transmission, the driving force of the handle 25 is transmitted from an epicycle reduction gear mechanism (a power transmission mechanism) 102, which will be described later, to the spool 13, whereby the spool 13 is caused to rotate in the winding direction.

In addition, the embodiment is characterized in that in place of the pivot s of the electric reel j in FIG. 5, the base 103 of the pivot 95 which supports the coupling gear 93 is secured to the supporting plate 15 which is disposed on an opposite side to the spool across the pivot 95 (that is, the base 103 is secured to the supporting plate 15 so that the one-way clutch is interposed between the base and the spool in an axial direction of the one-way clutch). In addition, the pivot 95 is made of the same material as that of the pivot S.

Namely, a pivot mounting hole 105 having a rotation preventive portion 104 for preventing the rotation of the base 103 of the pivot 95 is provided in the supporting plate 15 which is formed into the flat shape which extends along the high-speed output gear 95, the coupling gear 93 and the like, whereby the pivot 95 is inserted into the pivot mounting hole 105 from the outside of the supporting plate 15 and the base 103 can be secured to the rotation preventive portion 104. Thus, a construction is provided in which a roller 98 of the one-way clutch 97 is brought into abutment with an outer circumference of the pivot 95, and the bearing 101 which supports the coupling gear 93 on the supporting plate 15 is disposed radially outwards of the one-way clutch 97.

Because of this, compared to the conventional construction in FIG. 5 in which the bearing t and the one-way clutch p are disposed adjacent to and spaced apart from each other in the axial direction of the pivot s, the pivot 95 is made short in length (the supporting portion of the coupling gear 93 being made short in length) and the base 103 is secured to the supporting plate 15 which lies on the opposite side to the spool across the pivot 95, whereby a construction results in which the base 103 is disposed to be spaced apart from a magnet 139 of a rotation detecting unit 135, which will be described later, compared to the conventional construction shown in FIG. 5.

In addition, as is shown in FIG. 1, the spool shaft 11 passes through the center of the spool 13 to project into the side plate 3 at the other end thereof, and a second epicycle reduction gear mechanism 102 is attached to a projecting end of the spool shaft 11 for allowing the driving force of the motor 23 and the rotational force of the handle 25 which is produced as a result of a rotating operation thereof.

As in the case with the conventional electric reels, the epicycle reduction gear mechanism 102 includes a sun gear 106 which is fitted on the projecting end of the spool shaft 11 in such a manner as not to rotate thereon, a plurality of planetary gears 107 which mesh with the sun gear 106, and an internal gear 109 attached to the one end of the spool 13, and the planetary gears 107 mesh with the internal gear 119 and the sun gear 106. In addition, the planetary gears 107 are attached to a planetary gear carrier 113 via pivots 111, and the planetary gear carrier 113 fits in a bracket 115 which is attached to the spool 13 and is supported rotatably on a pinion shaft 119 via a bearing 117.

Additionally, in FIG. 1, reference numeral 25 denotes the handle, which has already been described, adapted to be operated for winding a fishing line and the handle 25 is attached rotatably to a projecting end, which lies to face the side plate 3, of a handle shaft 121 which is securely and rotatably inserted through the side plate 3. In addition, a ratchet 123 is secured to the handle shaft 121 inside the side plate 3, and furthermore, a driving gear 125 is attached rotatably to the handle shaft 121. The driving gear 125 and the handle shaft 121 are friction connected by a known drag unit 127 which is mounted on the handle shaft 121. Thus, when a drag force adjusting lever 129 is operated, the drag force of the drag unit 127 is made to be adjusted.

In addition, since the rotation of the coupling gear 93 which meshes with the spool shaft driving gear 21 is prevented by the wedging action of the one-way clutch 97 when the handle is operated for winding as has been described above, the rotational force of the handle 25 is transmitted to the spool 13 from the epicycle reduction gear mechanism 102, whereby the spool 13 is made to rotate in a winding direction.

Additionally, although not shown, a known check pawl which is biased by a spring is locked on the ratchet 123, whereby a backward rotation of the spool 13 is checked by the check pawl being locked on the ratchet 123 in that way.

In addition, although not shown, a known clutch return projection is provided on the ratchet 123, whereby a known clutch return mechanism utilizing the rotation of the handle 25 is configured. Furthermore, a one-way clutch K is provided between the handle shaft 121 and the side plate 3, whereby a backward rotation preventing mechanism of the handle shaft 121 is configured.

Furthermore, although not shown, in addition to the mechanical change-speed mechanism 31 that has already been described above, an electric change-speed mechanism similar to an electric reel disclosed in the Japanese Patent No. 2977978 is mounted on the electric reel 7 of the embodiment, and a lever-shaped motor output adjustor (hereinafter, referred to as a “power lever”) is attached to a front of a side portion of the side plate 3 which faces the handle 25 in such a manner as to be rotationally operated in a longitudinal direction of the reel main body 9 over a predetermined angle (for example, a range of 120°).

The power lever is coupled to an operation shaft of a potentiometer which is incorporated in the side plate 3, and a change in resistance value of the potentiometer which is produced in association with the rotational operation of the power lever is made to be inputted into a microcomputer mounted within a known control box, not shown, provided on the reel main body 9.

Then, the microcomputer variably controls the motor driving current energization time rate by a switching element connected to a position along a motor driving circuit as a duty ratio of a pulse signal in accordance with a displacement of the power lever, so as to adjust the motor output of the motor 23 to be increased or decreased.

Furthermore, a clutch lever 133 for controlling a known clutch mechanism 131 mounted inside the side plate is attached at the rear of the spool 13 between the side plates 1, 3 in such a manner as to be pressingly operated downwards, whereby the clutch mechanism 131 is made to be switched between a clutch-on state and a clutch-off state by the clutch lever 133 being so pressingly operated. Then, the clutch mechanism 131 is made to return to the clutch-on state via the clutch return mechanism that has already been described above, when the handle 25 is rotated in the winding direction in the clutch-off state, whereby the spool 13 is switched between a fishing line winding state and a spool free state by the clutch lever 133 and the handle 25 performing the clutch on/off switching operation, so as to enable the transmission/interruption of the rotational force of the motor 23 and the handle 25 to the spool 13.

In addition, in FIG. 1, reference numeral 135 denotes a rotation detecting unit for detecting the rotating speed and direction of the spool 13, and this rotation detecting unit 135 is made up or a magnetic sensor 137 which is made up, in turn, of a Hall element and a reed switch which are mounted on the set plate 15 and a plurality of magnets 139 which are secured to a circumferential edge portion of the one end of the spool 13, the magnetic sensor 137 being connected to the microcomputer.

Thus, a CPU of the microcomputer is configured not only to take in, as with a line length measuring program disclosed in JP-A-5-103567, a rotating direction determination signal outputted from the magnetic sensor 137 which indicates the rotating direction, forwards or backwards, of the spool 13 so as to determine whether the fishing line is being wound or unwound but also to count rotation pulse signals of the spool 13 which are taken in from the magnetic sensor 137 so as to execute an operation of a line length calculation stored in a ROM of the microcomputer.

Then, the microcomputer is made to display the result (a line length) of the operation on a display (not shown) provided on a control panel of the control box, whereby the angler is allowed to unwind the fishing line to place a hook and a bait to a predetermined depth in the water or wind the fishing line by controlling the handle 25 or the power lever while verifying what is displayed on the display.

Furthermore, a change-speed HI/LOW switch, not shown, is mounted adjacent to the display on the control panel, not shown, on the reel main body 9, and this change-speed HI/LOW switch is connected to the microcomputer. Then, the microcomputer is configured to first cause the motor 23 to rotate forwards when the change-speed HI/LOW switch is pushed and thereafter to switch alternately the rotating directions of the motor 23 between forwards and backwards in response to the pushing operation of the change-speed HI/LOW switch, whereby the mechanical change-speed mechanism 31 is made to switch alternately between the low-speed power transmission state by the low-speed gear transmission mechanism 59 and the high-speed power transmission state by the high-speed gear transmission mechanism 63.

In addition, letters, “HI” or “LOW,” are made to be displayed on the display in response to the mechanical change-speed mechanism 31 being switched to the high-speed power transmission state or the low-speed power transmission state.

The electric reel 7 according to the embodiment is configured as has been described heretofore, in which when the clutch lever 133 is operated to be off, the fishing line is unwound from the spool 13, whereas when the handle 25 is rotated in the winding direction or the clutch lever 133 is operated to put the clutch on, the clutch mechanism 131 is returned to the clutch-on state or puts the clutch on, allowing the fishing line to be wound on to the spool 13 when the power lever drives the motor 23 for winding or the handle 25 is operated for winding, and the line length is measured to be displayed on the display based on a detection value by the rotation detecting unit 135 in association with the fishing line being unwound or wound, while the rotation of the motor 23 which is controlled to be driven by the control of the power lever is decelerated by the epicycle reduction gear mechanism 29 to be transmitted to the mechanical change-speed mechanism 31.

Then, by push controlling the change-speed HI/LOW switch, the mechanical change-speed mechanism 31 is made to switch between the low-speed power transmission state by the low-speed gear transmission mechanism 59 and the high-speed power transmission state by the high-speed gear transmission mechanism 63.

Namely, when the change-speed HI/LOW switch is operated, the microcomputer first sends out a command to the motor drive circuit so as to cause the motor 23 to rotate forwards in order for the rotation of the motor 23 to be transmitted to the spool 13 via the high-speed gear transmitting mechanism 63.

As this occurs, the motor 23 is being driven to rotate by a motor output in accordance with an amount by which the power lever is operated, and when the power lever is in a motor-stop state, the motor 23 is not driven irrespective of the operation of the change-speed HI/LOW switch.

Thus, when the motor 23 rotates forwards in the manner described above, the sun gear 35 of the epicycle reduction gear mechanism 29 rotates in the same direction, while the planetary gears 49 walk round the circumference of the sun gear 35 while revolving counterclockwise on the corresponding pivots, whereby the planetary gear carrier 53 is caused to rotate forwards.

Then, since when the planetary gear carrier 53 rotates forwards, the output gear 57 rotates in the same direction, the low-speed input gear 61 and the high-speed input gear 65 which mesh with the output gear 57 rotate backwards together, and the rotation of the high-speed input gear 65 is transmitted to the pivot 73 by virtue of the wedging action of the one-way clutch 75 on the side of the high-speed gear transmission mechanism 63. On the other hand, the one-way clutch 69 on the side of the low-speed gear transmission mechanism 59 does not transmit the rotation of the low-speed gear input gear 61 to the pivot 67, whereby the pivot 67 and the low-speed output gear 89 which attached thereto are put in a spinning state.

When the rotation of the high-speed input gear 65 is transmitted to the pivot 73, the high-speed output gear 91, which is fitted on the pivot 73 in such a manner as not to rotate thereon, rotates, whereby the driving force of the pivot 73 is transmitted to the spool shaft 11 from the coupling gear 93 of the power transmission mechanism 19 and the spool shaft driving gear 21, and the spool 13 is driven in the high-speed power transmission state. As this occurs, the low-speed output gear 89, which meshes with the high-speed output gear 91, spins and hence, the low-speed gear transmission mechanism 59 does not function.

Then, when the change-speed HI/LOW switch is operated in this high-speed power transmission state, the microcomputer sends out a command to the motor drive circuit to temporarily stops the motor 23 and thereafter causes the motor 23 to rotate backwards.

Thus, when the motor 23 rotates backwards in the manner described above, the sun gear 35 of the epicycle reduction gear mechanism 29 rotates in the same direction, while the planetary gears 49 walk round the circumference of the sun gear 35 while revolving clockwise on the corresponding pivots, whereby the planetary gear carrier 53 is caused to rotate backwards, and the output gear 57 which is integral with the planetary gear carrier 53 rotates in the same direction.

In association with the backward rotation of the output shaft 57, the low-speed input gear 61 and the high-speed input gear 65 which mesh with the output shaft 57 rotate forwards, whereby the rotation of the low-speed input gear 61 is transmitted to the pivot 67 by virtue of the wedging action of the one-way clutch 69 on the side of the low-speed gear transmission mechanism 59. Then, the one-way clutch 75 on the side of the high-speed gear transmission mechanism 63 does not transmit the rotation of the high-speed input gear 65 to the pivot 73, whereby the pivot 73 and the high-speed output gear 91 which meshes with the pivot 73 are put in a spinning state.

When the rotation of the low-speed input gear 61 is transmitted to the pivot 67 in this way, the low-speed output gear 89, which is fitted on the pivot 67 in such a manner as not to rotate thereon, rotates, whereby the driving force of the pivot 67 is transmitted to the spool shaft 11 by way of the power transmission mechanism 19 via the high-speed output gear 91 which meshes with the low-speed output gear 89 and which is in the spinning state, and the spool 13 is driven in the low-speed power transmission state.

Thereafter, the mechanical change-speed mechanism 31 is made to switch between the high-speed power transmission state by the high-speed gear transmission mechanism 63 and the low-speed power transmission state by the low-speed gear transmission mechanism 59 in response to the change-speed HI/LOW switch being push operated.

In addition, due to the construction in which the part of the motor casing 27 which lies on the opposite side to the side thereof which faces the handle 25 is partitioned by the first wall portion 39 and the second wall portion 41 to define the storage portion 45 so that the epicycle reduction gear mechanism 29 is stored in the interior of the storage portion 45, the storing spaces for the epicycle reduction gear mechanism 29 and the mechanical change-speed mechanism 31 are separated from each other, whereby the resonance of meshing noise of the gears is suppressed or reduced effectively when compared to the conventional electric reel in JP-A-2006-325481.

In addition, while in the conventional electric reel disclosed in JP-A-2006-325481, due to the construction in which the driving force of the spool is finally transmitted from the single output shaft to the power transmission mechanism via the meshing transmission mechanism of the high-speed gear transmission mechanism and the low-speed gear transmission mechanism, the number of gears involved is large and the power transmitting portion cannot be silenced effectively, according to the embodiment, due to the construction in which the two output shafts, that is, the pivot 67 of the low-speed gear power transmission mechanism 59 and the pivot 73 of the high-speed gear power transmission mechanism 63, are provided, so that the driving force is made to be outputted from the respective output shafts, the number of gears involved is reduced, whereby the noise silencing can be realized.

Thus, in the embodiment, as with the conventional electric reel disclosed in JP-A-2006-325481, in transmitting the rotational driving force of the motor 23 to the spool shaft 11 by disposing sequentially the epicycle reduction gear mechanism 29, the mechanical change-speed mechanism 31 and the power transmission mechanism 19 between the motor 23 and the spool shaft 11, since it is configured such that firstly, the rotation of the motor 23 is decelerated once by the epicycle reduction gear mechanism 29 to be inputted into the mechanical change-speed mechanism 31, while the desired object can be attained as done in the conventional electric reel in Patent Document No. 2, according to the embodiment, as has been described before, in addition therefor, since the interior of the part of the motor casing 27 which lies opposite to the side which faces the handle 25 is partitioned by the first wall portion 39 and the second wall portion 41 to define the storage portion 45 so that the epicycle reduction gear mechanism 29 is stored in the storage portion 45, the storing spaces for the epicycle reduction gear mechanism 29 and the mechanical change-speed mechanism 31 are separated from each other, whereby the resonance of meshing noise of the gears is allowed to be suppressed or reduced effectively when compared to the conventional electric reel in Patent Document No. 2.

In addition, while in the conventional electric reel disclosed in Patent Document No. 2, due to the construction in which the driving force of the spool is finally transmitted from the single output shaft to the power transmission mechanism via the meshing transmission mechanism of the high-speed gear transmission mechanism and the low-speed gear transmission mechanism, the number of gears involved is large and the power transmitting portion can not be silenced effectively, according to the embodiment, due to the construction in which the two output shafts, that is, the pivot 67 of the low-speed gear power transmission mechanism 59 and the pivot 73 of the high-speed gear power transmission mechanism 63, are provided, so that the driving force of the motor 23 is made to be outputted from the respective output shafts to the power transmission mechanism 19, the number of gears involved is reduced and the construction is simplified, thereby providing an advantage that the effective noise silencing can be realized.

In addition, in the conventional electric reel, the number of gears involved is large and the sufficient silencing of the power transmitting portion is not attained due to the construction in which the driving force of the motor A is finally transmitted from the one output gear m to the power transmission mechanism D. However, according to the embodiment, since the two output shafts, that is, the pivot 67 of the low-speed gear power transmission mechanism 59 and the pivot 73 of the high-speed gear power transmission mechanism 63, are provided, so that the driving force is made to be outputted respectively from the low-speed output shaft 89 and the high-speed output shaft 91, the number of gears involved is reduced, whereby the noise silencing can be realized.

Furthermore, as has been described before, according to the embodiment, due to the construction in which the low-speed output gear 89, the high-speed output gear 91, the coupling gear 93 and the spool shaft driving gear 21 are disposed and mesh coupled together in the series fashion, the supporting plate 15, which supports the gears in the manner described above, is formed into the flat shape which extends along the respective gears 89, 91, 93, 21, the pivot 95 is secured to the supporting plate 15, the one-way clutch 97 is mounted on the outer circumference of the pivot 95 and the bearing 101 which supports the coupling gear 93 on the supporting plate 15 is disposed radially outwards of the one-way clutch 97, the reduction in length of the pivot 95 (the reduction in length of the supporting portion of the coupling gear 93) can be realized, compared to the conventional construction shown in FIG. 5.

Consequently, according to the embodiment, the overall size of the electric reel 7 can be made smaller by the reduction in length thereof in the axial direction, thereby an advantage being provided that the grip holding capability is increased to thereby increase the fishing operability.

Furthermore, since the pivot 95, which is made of a hard iron-based material which has been subjected to a hardening treatment, is inserted into the pivot mounting hole 105 provided in the supporting plate 15 from the outside thereof so that the base 103 of the pivot 95 is secured to the rotation preventive portion 104 of the supporting plate 15, the magnet 139 of the rotation detecting unit 135 is spaced apart from the base 103, compared to the conventional construction shown in FIG. 5.

Consequently, according to the embodiment, the magnet 139 for detecting the rotation of the spool can be mounted on the side of the spool 13 while realizing the reduction in size of the whole of the reel without affecting the free rotating performance of the spool 13 by avoiding the effect of magnetic line of force.

In addition, while the invention is applied to the electric reel 7 which changes winding speeds between high speed and low speed by making use of both the forward and backward rotations of the motor 23, the invention can, of course, be applied to an electric reel which realizes the switching control of a clutch by making use of both the forward and backward rotations of a motor as is disclosed in, for example, JP-A-2006-238736.

What is claimed is:

1. An electric fishing reel comprising:
a reel main body;
a spool rotatably supported by the reel main body for winding a fishing line;
a motor adapted to rotate forwards and backwards for driving the spool;
a motor casing which is provided on the reel main body, accommodates the motor therein and includes a first wall portion and a second wall portion spaced apart from the first wall portion in an axial direction of an output portion of the motor;
an epicycle reduction gear mechanism which reduces the rotating speed of the motor, is installed between the first and second wall portions and includes a planetary gear carrier which supports planetary gears of the epicycle reduction gear mechanism, is supported on the second wall portion and is integrally attached with an output gear;
a mechanical change-speed mechanism which includes an input gear meshing with the output gear of the planetary gear carrier and switches transmission of power of the motor between a high-speed power transmission state and a low-speed power transmission state by switching rotating directions of the motor; and
a power transmission mechanism which transmits output of the mechanical change-speed mechanism to the spool to rotate the spool.

2. The electric fishing reel according to claim 1, wherein
the mechanical change-speed mechanism includes:
a high-speed output shaft to which an output shaft is attached;
a first one-way clutch attached to the high-speed output shaft;
a first input gear attached to an outer ring of the first one-way clutch;
a low-speed output shaft to which an output shaft is attached;
a second one-way clutch which is attached to the low-speed output shaft; and
a second input gear which is attached to an outer ring of the second one-way clutch,
wherein the output gear of the planetary gear carrier meshes with the first and second input gears.

3. The electric fishing reel according to claim 2, wherein a high-speed output gear and a low-speed output gear which are attached, respectively, to the high-speed output shaft and the low-speed output shaft mesh with each other, and either of the first and second output gears meshes with a coupling gear of the power transmission mechanism.

4. The electric fishing reel according to claim 3, wherein the high-speed output gear, the low-speed output gear and the coupling gear are disposed in a series fashion.

5. An electric fishing reel comprising:
a reel main body that includes a supporting plate;
a spool shaft rotatably supported by the reel main body;
a spool rotatably supported by the reel main body and rotated by the spool shaft for winding a fishing line;
a motor adapted to rotate forwards and backwards for driving the spool;
an output gear for transmitting rotation of the motor;
a power transmission mechanism which receives rotation from the output gear and transmits the received rotation to the spool shaft; and
a manual handle for driving the spool,
wherein the power transmission mechanism includes:
a coupling gear meshing with the output gear;
a one-way clutch mounted on the coupling gear so that the spool is rotated by the driving force of the manual handle and the driving force of the manual handle is not transmitted to the motor; and
a pivot which supports the coupling gear through the one-way clutch and includes a base fixed to the supporting plate so that the one-way clutch is interposed between the base and the spool in an axial direction of the one-way clutch,
wherein the coupling gear and the output gear are disposed in a series fashion.

6. The electric fishing reel as set forth in claim 5, wherein
the power transmission mechanism includes a spool shaft driving gear which meshes with the coupling gear and is fixed to the spool shaft, and
the output gear, the coupling gear and the spool shaft driving gear are disposed in a series fashion.
